(19) United States
(12) Patent Application Publication
(10) Pub. No.: US 2013/0197133 A1
(43) Pub. Date: Aug. 1, 2013

(54) Biodegradable Hydrophobic Cellulosic Substrates And Methods For Their Production Using Halosilanes

(71) Applicants: Kevin Dale Lewis, Sanford, MI (US); James Habermehl, Midland, MI (US); William James Schulz, JR., Midland, MI (US)

(72) Inventors: Kevin Dale Lewis, Sanford, MI (US); James Habermehl, Midland, MI (US); William James Schulz, JR., Midland, MI (US)

(21) Appl. No.: 13/877,943

(22) PCT Filed: May 16, 2011
(86) PCT No.: PCT/US2011/036581

§ 371 Date: Apr. 5, 2013

Related U.S. Application Data
(60) Provisional application No. 61/390,653, filed on Oct. 7, 2010.

(51) Int. Cl. C09D 5/00

(52) U.S. Cl. CPC C09D 5/00
USPC 524/35; 427/331; 427/341; 427/255.6

(57) ABSTRACT

A method for rendering a substrate hydrophobic while maintaining its biodegradability includes treating the substrate with a halosilane such that the halosilane forms a silicone resin in the interstitial spaces of the substrate. The method parameters can be controlled such that the resulting hydrophobic cellulosic substrate is compostable.

### CROSS REFERENCE TO RELATED APPLICATIONS

None.

### TECHNICAL FIELD

A biodegradable, hydrophobic substrate, and a method for rendering the substrate hydrophobic is disclosed. A halosilane is used in the method.

### BACKGROUND

Cellulosic substrates such as paper and cardboard (such as corrugated fiberboard, paperboard, display board, or card stock) products encounter various environmental conditions based on their intended use. For example, cardboard is often used as packaging material for shipping and/or storing products and must provide a durable enclosure that protects its contents. Some such environmental conditions these packaging materials may face are water through rain, temperature variations which may promote condensation, flooding, snow, ice, frost, hail or any other form of moisture. Other products include disposable food service articles, which are commonly made from paper or paperboard. These cellulosic substrates also face moist environmental conditions, e.g., vapors and liquids from the foods and beverages they come in contact with. Water in its various forms may threaten a cellulosic substrate by degrading its chemical structure through hydrolysis and cleavage of the cellulose chains and/or breaking down its physical structure via irreversibly interfering with the hydrogen bonding between the chains, thus decreasing its performance in its intended use. When exposed to water, other aqueous fluids, or significant amounts of water vapor, items such as paper and cardboard may become soft, losing form-stability and becoming susceptible to puncture (e.g., during shipping of packaging materials or by cutlery such as knives and forks used on disposable food service articles).

Manufacturers may address the problem of the moisture-susceptibility of disposable food service articles by not using the disposable food service articles in moist environments. This approach avoids the problem simply by marketing their disposable food service articles for uses in which aqueous fluids or vapor are not present (e.g., dry or deep-fried items). However, this approach greatly limits the potential markets for these articles, since many food products (1) are aqueous (e.g., beverages, soups), (2) include an aqueous phase (e.g., thin sauces, vegetables heated in water), or (3) give off water vapor as they cool (e.g., rice and other starchy foods, hot sandwiches, etc.).

Another way of preserving cellulosic substrates is to prevent the interaction of water with the cellulosic substrate. For example, water-resistant coatings (e.g., polymeric water-proofing materials such as wax or polyethylene) may be applied to the surfaces of the cellulosic substrates to prevent water from contacting the cellulosic substrates directly. This approach essentially forms a laminated structure in which a water-sensitive core is sandwiched between layers of a water-resistant material. Many coatings, however, are costly to obtain and difficult to apply, thus increasing manufacturing cost and complexity and reducing the percentage of acceptable finished products. Furthermore, coatings can degrade or become mechanically compromised and become less effective over time. Coatings also have the inherent weakness of poorly treated substrate edges. Even if the edges can be treated to impart hydrophobicity to the entire substrate, any rips, tears, wrinkles, or folds in the treated substrate can result in the exposure of non-treated surfaces that are easily wetted and can allow wicking of water into the bulk of the substrate.

Furthermore, certain coatings and other known hydrophobing treatments for cellulosic substrates may also render the substrates not biodegradable. Therefore, it would be desirable to provide a method for rendering cellulosic substrates hydrophobic as well as maintaining their biodegradablity.

### SUMMARY

A method for rendering a substrate hydrophobic while maintaining its biodegradability is disclosed. The method includes penetrating the substrate with a halosilane and forming a silicone resin (resin) from the halosilane.

### DETAILED DESCRIPTION

All amounts, ratios, and percentages described herein are by weight unless otherwise indicated. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group a hydrogen atom, an alkyl group, an aryl group, an aralkyl group, or an alkaryl group includes the member alkyl individually; the subgroup alkyl and aryl; and any other individual member and subgroup subsumed therein.

The substrates useful in the method described herein are biodegradable. For purposes of this application, the terms ‘compostable,’ and ‘compostability’ encompass factors such as biodegradability, disintegration, and ecotoxicity. The terms ‘biodegradable,’ ‘biodegradability,’ and variants thereof refer to the nature of the material to be broken down by microorganisms. Biodegradable means a substrate breaks down through the action of a microorganism, such as a bacterium, fungus, enzyme, and/or virus over a period of time. The term ‘disintegration,’ ‘disintegrate,’ and variants thereof refer to the extent to which the material breaks down and falls apart. Ecotoxicity testing determines whether the material after composting shows any inhibition on plant growth or the survival of soil or other fauna. Biodegradability and compostability may be measured by visually inspecting a substrate that has been exposed to a biological inoculum (such as a bacterium, fungus, enzyme, and/or virus) to monitor for degradation. Alternatively, the biodegradable substrate passes ASTM Standard D6400; and alternatively the biodegradable substrate passes ASTM Standard D6868-03. In general, rate of compostability and/or biodegradability may be increased by maximizing surface area to volume ratio of each substrate. For example, surface area/volume ratio may be at least 10, alternatively at least 17. Alternatively, surface area/volume ratio may be at least 33. Without wishing to be bound by theory, it is thought that a surface area/volume ratio of at least 33 will allow the substrate to pass the test for biodegradability in ASTM Standard D6868-03. For purposes of this application, the terms ‘hydrophobic’ and ‘hydrophobicity,’ and variants thereof, refer to the water resistance of a substrate. Hydrophobicity may be measured according to the Cobb test set forth in Reference Example 2, below. The substrates treated by the method described herein may also be inherently recyclable. The substrates may also be repulpable, e.g., the hydrophobic substrate prepared by the method described herein may be reduced to pulp for use in making paper. The substrates may also be repurposeable.

A substrate can be rendered hydrophobic by treating the substrate with a halosilane. Alternatively, the substrate can be rendered hydrophobic by treating the substrate with a plurality of halosilanes, where the plurality of halosilanes comprises a first halosilane and a second halosilane different from the first halosilane. The plurality of halosilanes can comprise a total halosilane concentration of 20 mole percent or less of monohalosilanes and 70 mole percent or less of monohalosilanes and dihalosilanes. The plurality of halosilanes can be applied as one or more liquids such that the plurality of halosilanes penetrates the substrate. Alternatively, the plurality of halosilanes may be applied as one or more vapors such that the plurality of halosilanes penetrates the substrate.

The halosilane can be applied in any manner such that the halosilane penetrates the substrate and produces a silicone resin in the interstitial spaces of the substrate (the volume, as well as the surface, of the substrate is rendered hydrophobic). In addition, by varying the amount and the type of the halosilane, the physical properties of the substrate may be altered. All or a portion of the volume may be rendered hydrophobic. Alternatively, the entire volume of the substrate may be rendered hydrophobic.

Suitable biodegradable substrates for use herein may be cellulosic substrates. Cellulosic substrates are substrates that substantially comprise the polymeric organic compound cellulose having the formula (C₆H₁₀O₅)ₙ where n is any integer. Cellulosic substrates possess —OH functionality, contain water, and optionally other ingredients that may react with the halosilane compound, such as lignin. Lignin is a polymer that results from the copolymerization of a mixture of monolignols such as p-coumaryl alcohol, coniferyl alcohol, and/or sinapyl alcohol. This polymer has residual —OH functionality with which the halosilane can react. Examples of suitable substrates include, but are not limited to, paper, wood and wood products, cardboard, wallboard, textiles, starches, cotton, wool, other natural fibers, or biodegradable composites derived there from. Depending on the substrate's intended application and manufacturing process, the substrate can comprise sizing agents and/or additional additives or agents to alter its physical properties or assist in the manufacturing process. Exemplary sizing agents include starch, rosin, alkyl ketene dimer, alkenyl succinic acid anhydride, styrene maleic anhydride, glue, gelatin, modified celluloses, synthetic resins, latexes and waxes. Other exemplary additives and agents include bleaching additives (such as chlorine dioxide, oxygen, ozone and hydrogen peroxide), wet strength agents, dry strength agents, fluorescent whitening agents, calcium carbonate, optical brightening agents, antimicrobial agents, dyes, retention aids (such as anionic polyacrylamide and polydiallydimethylammonium chloride, drainage aids (such as high molecular weight cationic acrylamide copolymers, bentonite and colloidal silicas), biocides, fungicides, slimacides, talc and clay and other substrate modifiers such as organic amines including triethylamine and benzylamine. It should be appreciated that other sizing agents and additional additives or agents not listed explicitly herein may alternatively be applied, alone or in combination. For example, where the substrate comprises paper, the paper can also comprise or have undergone bleaching to whiten the paper, starching or other sizing operation to stiffen the paper, clay coating to provide a printable surface, or other alternative treatments to modify or adjust its properties. Furthermore, substrates such as paper can comprise virgin fibers, wherein the paper is created for the first time from non-recycled cellulose compounds, recycled fibers, wherein the paper is created from previously used cellulosic materials, or combinations thereof.

The substrate may vary in thickness and/or weight depending on the type and dimensions of the substrate. The thickness of the substrate can range from less than 1 mil (where 1 mil=0.001 inches=0.0254 millimeters (mm)) to greater than 150 mils (3.81 mm), from 10 mils (0.254 mm) to 60 mils (1.52 mm), from 20 mils (0.508 mm) to 45 mils (1.143 mm), from 30 mils (0.762 mm) to 45 mils (1.143 mm), from 24 mils to 45 mils, or alternatively from 24 mils to 35 mils, or have any other thickness that allows it to be treated with the halosilane or solution, but still remain biodegradable, as will become appreciated herein. The thickness of the substrate can be uniform or vary and the substrate can comprise one continuous piece of material or comprise a material with openings such as pores, apertures, or holes disposed therein. Furthermore, the substrate may comprise a single flat substrate (such as a single flat piece of paper) or may comprise a folded, assembled or otherwise manufactured substrate (such as a box or envelope). For example, the substrate can comprise multiple substrates glued, rolled or woven together or can comprise varying geometries such as corrugated cardboard. In addition, the substrates can comprise a subset component of a larger substrate such as when the substrate is combined with plastics, fabrics, non-woven materials and/or glass. It should be appreciated that substrates may thereby embody a variety of different materials, shapes and configurations and should not be limited to the exemplary embodiments expressly listed herein.

Furthermore, as will become better appreciated herein, the substrate can be provided in an environment with a controlled temperature. For example, the substrate can be provided at a temperature ranging from −40° C. to 200° C., alternatively 10° C. to 80° C., or alternatively 22° C. to 25° C.

In the method described herein, the substrate is treated with a halosilane, alternatively a plurality of halosilanes. The halosilane may penetrate the substrate as one or more liquids to render the substrate hydrophobic. Alternatively, the halosilane may penetrate the substrate as one or more vapors. When a plurality of halosilanes is used, the plurality of halosilanes may penetrate the substrate as one or more vapors. When a plurality of halosilanes is used, the plurality of halosilanes comprises at least a first halosilane and a second halosilane different from the first halosilane. The phrase “different from” as used herein means two non-identical halosilanes so that the substrate is not treated with a single halosilane. For purposes of this application, a ‘halosilane’ is defined as a silane that has at least one halogen (such as, for example, chlorine or fluorine) directly bonded to silicon wherein, within the scope of this disclosure, silanes are defined as silicon-based monomers or oligomers that contain functionality that can react with water, the —OH groups on the substrates (e.g., cellulosic substrates) and/or sizing agents or additional additives applied to the substrates as appreciated herein. Halosilanes with a single halogen directly bonded to silicon are defined as monohalosilanes, halosilanes with two halogens directly bonded to silicon are defined as dihalosilanes, halosilanes with three halogens directly bonded to silicon are defined as trihalosilanes and halosilanes with four halogens directly bonded to silicon are defined as tetrahalosilanes.

Monomeric halosilanes can comprise the formula RₐSiX_{b}H_{(4-a-b)} where subscript a has a value ranging from 0 to 3, or alternatively, a=0-2, subscript b has a value ranging from 1 to 4, or alternatively, b=2-4, each X is independently chloro, fluoro, bromo or iodo, or alternatively, each X is chloro, and each R is independently a monovalent hydrocarbon group, or alternatively each R is an alkyl, alkenyl, aryl, aralkyl, or alkaryl group containing 1 to 20 carbon atoms. Alternatively, each R is independently an alkyl group containing 1 to 11 carbon atoms, an aryl group containing 6 to 14 carbon atoms, or an alkenyl group containing 2 to 12 carbon atoms. Alternatively, each R is methyl or octyl. One such exemplary halosilane is methyltrichlorosilane or MeSiCl₃ where Me represents a methyl group (CH₃). Another exemplary halosilane is dimethyldichlorosilane or Me₂SiCl₂. Further examples of halosilanes include (chloromethyl)trichlorosilane, [3-(heptafluoroisoproxy)propyl]trichlorosilane, 1,6-bis(trichlorosilyl)hexane, 3-bromopropyltrichlorosilane, bromotrimethylsilane, allylbromodimethylsilane, allyltrichlorosilane, (bromomethyl)chlorodimethylsilane, chloro(chloromethyl)dimethylsilane, bromodimethylsilane, chloro(chloromethyl)dimethylsilane, chlorodiisopropyloctysilane, chlorodiisopropylsilane, chlorodimethylethylsilane, chlorodimethylphenylsilane, chlorodimethylsilane, chlorodiphenylmethylsilane, chlorotriethylsilane, chlorotrimethylsilane, dichloromethylsilane, dichlorodimethylsilane, dichloromethylvinylsilane, diethyldichlorosilane, diphenyldichlorosilane, di-t-butylchlorosilane, ethyltrichlorosilane, iodotrimethylsilane, octyltrichlorosilane, pentyltrichlorosilane, propyltrichlorosilane, phenyltrichlorosilane, triphenylsilylchloride, tetrachlorosilane, trichloro(3,3,3-trifluoropropyl)silane, trichloro(dichloromethyl)silane, trichlorovinylsilane, hexachlorodisilane, 2,2-dimethylhexachlorotrisilane, dimethyldifluorosilane, or bromochlorodimethylsilane. These and other halo silanes can be produced through methods known in the art or purchased from suppliers such as Dow Corning Corporation of Midland, Mich., USA, Momentive Performance Materials of Albany, N.Y., USA, or Gelest, Inc. of Morrisville, Pa., USA. Furthermore, while specific examples of halosilanes are explicitly listed herein, the above-disclosed examples are not intended to be limiting in nature. Rather, the above-disclosed list is merely exemplary and other halosilane compounds, such as oligomeric halosilanes and polyfunctional halosilanes, may also be used.

When a plurality of halosilanes is used, the plurality of halosilanes may be provided such that each halosilane comprises a mole percent of a total halosilane concentration. For example, where the plurality of halosilanes comprises only two halosilanes, the first halosilane will comprise X′ mole percent of the total halosilane concentration while the second halosilane will comprise 100-X′ mole percent of the total halosilane concentration. To promote the formation of a resin when treating the substrate with the plurality of halosilanes as will become appreciated herein, the total halosilane concentration of the plurality of halosilanes can comprise 20 mole percent or less of monohalosilanes, 70 mole percent or less of monohalosilanes and dihalosilanes (i.e., the total amount of monohalosilanes and dihalosilanes when combined does not exceed 70 mole percent), and at least 30 mole percent of trihalosilanes and tetrahalosilanes (i.e., the total amount of trihalosilanes and tetrahalosilanes when combined comprises at least 30 mole percent). In another embodiment, total halosilane concentration of the plurality of halosilanes can comprise 30 mole percent to 80 mole percent of trihalosilanes and/or tetrahalosilanes, or alternatively, 50 mole percent to 80 mole percent of trihalosilanes and/or tetrahalosilanes.

For example, in one exemplary embodiment, the first halosilane can comprise a trihalosilane (such as MeSiCl₃) and the second halosilane can comprise a dihalosilane (such as Me₂SiCl₂). The first and second halosilanes (e.g., the trihalosilane and dihalosilane) can be combined such that the trihalosilane can comprise X′ percent of the total halosilane concentration where X′ is 90 mole percent to 50 mole percent, 80 mole percent to 55 mole percent, or 65 mole percent to 55 mole percent. These ranges are intended to be exemplary only and not limiting in nature and that other variations or subsets may alternatively be utilized.

The halosilane may be applied to the substrate in a vapor or liquid form. Alternatively, the halosilane may be applied to the substrate as one or more liquids. Specifically, each halosilane (e.g., a first halosilane and any additional halosilanes) can be applied to the substrate as a liquid, either alone or in combination, with other halosilanes. As used herein, liquid refers to a fluid material having no fixed shape. In one embodiment, each halosilane, alone or in combination, can comprise a liquid itself. In another embodiment, each halosilane can be provided in a solution (where at least the first halosilane is combined with a solvent prior to treatment of the substrate) to create or maintain a liquid state. As used herein, “solution” comprises any combination of a) one or more halosilanes and b) one or more other ingredients in a liquid state. The other ingredient may be a solvent, a surfactant, or a combination thereof. In such an embodiment, the halosilane may originally comprise any form such that it combines with the other ingredient to form a liquid solution. The surfactant useful herein is not critical and any of well-known nonionic, cationic and anionic surfactants may be useful. Examples include nonionic surfactants such as polyoxyethylene alkyl ethers, polyoxyethylene alkyl phenyl ethers, polyoxyethylene carboxylate, sorbitan fatty acid esters, polyoxyethylene sorbitan fatty acid esters, and polyether-modified silicones; cationic surfactants such as alkyltrimethylammonium chloride and alkylbenzylammonium chloride; anionic surfactants such as alkyl or alkylallyl sulfates, alkyl or alkylallyl sulfonates, and dialkyl sulfosuccinates; and ampholytic surfactants such as amino acid and betaine type surfactants. Suitable surfactants such as alkylethoxylates are commercially available. Other suitable surfactants include silicone polyethers, which are commercially available from Dow Corning Corporation of Midland, Mich., U.S.A. Other suitable surfactants include fluorinated hydrocarbon surfactants, fluorosilicone surfactants, alkyl and/or aryl quaternary ammonium salts, polypropyleneoxide/polyethyleneoxide copolymers such as PLURONICS® from BASF, or alkyl sulfonates.

In yet another embodiment, a plurality of halosilanes can be provided in a single solution (e.g., where the first halosilane and the second halosilane are combined with the other ingredient before treatment of the substrate). The plurality of halosilanes, either alone or in any combination, may thereby comprise a liquid or comprise any other state that combines with another ingredient to comprise a liquid so that the halosilanes are applied to the substrate as one or more liquids. The various halosilanes may therefore be applied as one or more liquids simultaneously, sequentially or in any combination thereof onto the substrate.

Thus, in one embodiment, a halosilane solution can be produced by combining at least the first halosilane (and any additional halosilanes) with a solvent. A solvent is defined as a substance that will either dissolve the halosilane to form a liquid solution or substance that provides a stable emulsion or dispersion of halosilane that maintains uniformity for sufficient time to allow penetration of the substrate. Appropriate solvents can be non-polar such as non-functional silanes (i.e., silanes that do not contain a reactive functionality such as tetramethylsilane), silicones, alkyl hydrocarbons, aromatic hydrocarbons, or hydrocarbons possessing both alkyl and aromatic groups; polar solvents from a number of chemical classes such as ethers, ketones, esters, thioethers, halohydrocarbons; and combinations thereof. Specific nonlimiting examples of appropriate solvents include isopentane, pentane, hexane, heptane, petroleum ether, ligroin, benzene, toluene, xylene, naphthalene, α- and/or β-methylnaphthalene, diethylether, tetrahydrofuran, dioxane, methyl-t-butylether, acetone, methylethylketone, methylisobutylketone, methylacetate, ethylacetate, butylacetate, dimethylthioether, diethylthioether, dipropylthioether, dibutylthioether, dichloromethane, chloroform, chlorobenzene, tetramethylsilane, tetraethylsilane, hexamethyldisiloxane, octamethyltrisiloxane, hexamethylcyclotrisiloxane, octamethylcyclotetrasiloxane, and decamethylcyclopentasiloxane. For example, in one specific embodiment, the solvent comprises a hydrocarbon such as pentane, hexane or heptane. In another embodiment, the solvent comprises a polar solvent such as acetone. Other exemplary solvents include toluene, naphthalene, isododecane, petroleum ether, tetrahydrofuran (THF) or silicones. The halosilane and the solvent can be combined to produce a solution through any available mixing mechanism. The halosilane can be either miscible or dispersible with the solvent to allow for a uniform solution, emulsion, or dispersion.

When a solution is used, the halosilane will comprise a certain weight percent of the solution. The weight percent specifically refers to the weight of the halosilanes (e.g., when a plurality of halosilanes is used, the first halosilane, the second halosilane and any additional halosilanes) with respect to the overall weight of solution (including any solvents or other ingredients used therein). Exemplary ranges of the amount of halosilane in the solution include from greater than 0% to 40%, or alternatively from greater than 0% to 5%, alternatively from 5% to 10%, alternatively from 10% to 15%, alternatively from 15% to 20%, alternatively from 20% to 25%, alternatively from 25% to 30%, alternatively from 30% to 35%, or alternatively from 35% to 40%. As noted earlier, these ranges are intended to be exemplary only and not limiting on the disclosure. Accordingly, other embodiments may incorporate an alternative weight percent of the halosilane in the solution even though not explicitly stated herein.

Once the halosilane is provided (either separately, as a solution, or combinations thereof), the substrate is treated with the halosilane to render the substrate hydrophobic. The term “treated” (and its variants such as “treating,” “treat,” “treats,” and “treatment”) means applying the halosilane to the substrate in an appropriate environment for a sufficient amount of time for the halosilane to penetrate the substrate and react to form a resin. The term “penetrate” (and its variants such as “penetrating,” “penetration,” “penetrated,” and “penetrates”) means that the halosilane enters some or all of the interstitial spaces of the substrate, and the halosilane does not merely form a surface coating on the substrate. Without intending to be bound by a particular theory or mechanism, it is thought that the halosilane can react with the —OH functionality of the substrate, the water within the substrate and/or other sizing agents or additional additives therein to form the resin. The resin refers to any product of the reaction between the halosilane and the —OH functionality of the substrate, the water within the substrate and/or other sizing agents or additional additives therein; which renders the substrate hydrophobic. Specifically, the halosilanes capable of forming two or more bonds can react with the hydroxyl groups distributed along the cellulose chains of a cellulosic substrate and/or the water contained therein to form a silicone resin disposed throughout the interstitial spaces of the cellulosic substrate and anchored to the cellulose chains of the cellulosic substrate. Where the halosilane reacts with the water in the substrate, the reaction can produce an HX product (where X is the halogen from the halosilane compound) and a silanol. The silanol may then further react with a halosilane or another silanol to produce the silicone resin. The different reaction mechanisms can continue substantially throughout the matrix of the substrate, thereby treating a part of the volume, or the entire volume, of a substrate of appropriate thickness. When the halosilane penetrates all the way through the thickness of the substrate, the entire volume of the substrate can be treated.

Penetrating the substrate with the halosilane can be achieved in a variety of ways. For example, without intending to be limited to the exemplary embodiments expressly disclosed herein, the halosilane or a solution can be applied to the substrate by being dropped onto the substrate (e.g., through a nozzle or die), by being sprayed (e.g., through a nozzle) onto one or more surfaces of the substrate, by being poured onto the substrate, by immersion (e.g., by passing the substrate through a contained amount of the halosilane compound or solution), by dipping the substrate into the halosilane compound or solution), or by any other method that can coat, soak, or otherwise allow the halosilane to come into physical contact with the substrate and enter interstitial spaces in the substrate. In one embodiment, where halosilanes are applied separately (e.g., not as a single solution), the first halosilane, the second halosilane, and any additional halosilanes can be applied simultaneously or sequentially to the substrate or in any other repeating or alternating order. Alternatively, where a combination of separate halosilanes and solutions are used, the halosilanes and solutions may also be applied simultaneously or sequentially or in any other repeating or alternating order.

Alternatively, without intending to be limited to the exemplary embodiments expressly disclosed herein, the halosilane or a solution can be applied to the substrate in vapor form by passing the substrate through a chamber containing vapor of the halosilane or introducing a halosilane in vapor form directly onto the surface of the substrate.

For example, in one embodiment, where the substrate comprises a roll of paper, the paper can be unrolled at a controlled velocity and passed through a treatment area where the halosilane is dropped onto the top surface of the paper. The velocity of the paper can depend in part on the thickness of the paper and/or the amount of halosilane to be applied and can range from 1 feet/minute (ft./min.) to 3000 ft./min., from 10 ft./min. to 1000 ft./min. or 20 ft./min to 500 ft./min. Within the treatment area one or more nozzles may drop a solution onto one or both surfaces of the substrate so that one or both surfaces of the substrate is covered with the solution.

The substrate treated with the halosilane can then rest, travel or experience additional treatments to allow the halosilane to react with the substrate and/or the water therein. For example, to allow for an adequate amount of time for reaction, the substrate may be stored in a heated, cooled and/or humidity-controlled chamber and allowed to remain for an adequate residence time, or may alternatively travel about a specified path wherein the length of the path is adjusted such that the substrate traverses the specified path in an amount of time adequate for the reaction to occur.

The method may further comprise exposing the treated substrate to a basic compound (such as ammonia gas) after the halosilane is applied to the substrate. The term ‘basic compound’ refers to any chemical compound that has the ability to react with and neutralize the acid (e.g., HX) produced upon hydrolysis of the halosilane. For example, in one embodiment, the halosilane may be applied to the substrate and passed through a chamber containing ammonia gas such that the substrate is exposed to the ammonia gas. Without intending to be bound by a particular theory, the basic compound may both neutralize acids generated from applying the halosilane to the substrate and further drive the reaction between the halosilane and water, and/or the substrate, to completion. Other non-limiting examples of useful basic compounds include both organic and inorganic bases such as hydroxides of alkali metals or amines. Alternatively, any other base and/or condensation catalyst may be used in whole or in part in place of the ammonia and delivered as a gas, a liquid, or in solution. In this context, the term “condensation catalyst” refers to any catalyst that can affect reaction between two silanol groups or a silanol group and a group formed in situ as a result of the reaction of the halosilane with an —OH group (e.g., bonded to cellulose) to produce a siloxane linkage. In yet another embodiment, the substrate may be exposed to the basic compound before, simultaneous with or after the halosilane is applied, or in combinations thereof.

To increase the rate of reaction, the substrate can also optionally be heated and/or dried after the halosilane is applied to produce the resin in the substrate. For example, the substrate can pass through a drying chamber in which heat is applied to the substrate. The temperature of the drying chamber will depend on the type of substrate and its residence time therein, however, the temperature in the chamber may comprise a temperature in excess of 200° C. Alternatively, the temperature can vary depending on factors including the type of substrate, the speed in which the substrate passes through the drying chamber, the thickness of the substrate, and/or the amount of the halosilane applied to the substrate. Alternatively, the temperature provided to the substrate may be sufficient to heat the substrate to 200° C. upon its exit from the drying chamber.

Once the substrate is treated to render it hydrophobic, the hydrophobic substrate will comprise the silicone resin from the reaction between the halosilane and the cellulosic substrate and/or the water within the substrate as discussed above. The resin can comprise anywhere from greater than 0% of the hydrophobic substrate to less than 1% of the hydrophobic substrate. The percent refers to the weight of the resin with respect to the overall weight of both the substrate and the resin. Other ranges of the amount of resin in the substrate include 0.01% to 0.99%, alternatively, 0.1% to 0.9%, alternatively 0.3% to 0.8%, and alternatively 0.3% to 0.5%. Without wishing to be bound by theory, it is thought that an amount of resin in the substrate less than that described above may provide insufficient hydrophobicity for the applications described herein, such as packaging material and disposable food service articles. At higher amounts of resin than that described above, it may be more difficult to compost the substrate at the end of its useful life.

Without intending to be bound by a particular theory, it is believed that by mixing different halosilanes in varying ratios and amounts to form a plurality of halosilanes, the substrates treated with the plurality of halosilanes can attain different physical properties based in part on the types and amounts of the specific halosilanes employed. For example, an additional benefit of treating a substrate with a plurality of halosilanes as disclosed herein is that the treatment can result in a net strengthening of the substrate as well as imparting hydrophobicity. The resin formed within the cellulose fibers of a cellulosic substrate reinforce the substrate both by literally bridging the cellulose fibers with chemical bonds to the silicon atom (via reaction with a portion of the —OH groups along the cellulose chain) and by forming a resin network within the interstitial spaces between the fibers. In particular, such a resin may strengthen substrates comprising recycled fibers wherein the strength of the recycled fibers has been reduced with each recycling due to the reduction in length of cellulose fibers that occurs as a result of breaking down of the pulp. Thus, not only will the resin provide hydrophobic properties to the cellulosic structure, but other physical properties (such as, for example, wet tear strength and tensile strength) can also be maintained or improved relative to the untreated substrate as a result of treatment with the halosilane. In addition, it is further believed that by mixing different halosilanes in varying ratios and amounts to form a plurality of halosilanes, the deposition efficiencies of the halosilanes may increase allowing for the methods of rendering substrates hydrophobic to become more efficient by achieving greater halosilane deposition during treatment.

Furthermore, it has been surprisingly found that the treated substrate prepared by the method described herein may be both hydrophobic and biodegradable. The amount of resin in the substrate need not be as high as in previously disclosed treatment methods; it has been found that greater than 0% to less than 1%, alternatively 0.01% to 0.99%, alternatively, 0.1% to 0.9%, alternatively 0.3% to 0.8%, and alternatively 0.3% to 0.5% resin in the substrate provides sufficient hydrophobicity for the applications described herein, such as packaging material and disposable food service articles, while still maintaining the biodegradability of the substrate. At higher amounts of resin it may be more difficult to compost the substrate at the end of its useful life.

### EXAMPLES

The following examples are included to demonstrate the invention to one of ordinary skill. However, those of ordinary skill in the art should, in light of the present disclosure, appreciate that many changes can be made in the specific embodiments which are disclosed and still obtain a like or similar result without departing from the spirit and scope of the invention.

### Reference Example 1

### Disintegration Testing

The disintegration of paperboard was evaluated during 12 weeks of composting. The test items of paperboard were placed in slide frames and added to biowaste in an insulated composting bin. The biowaste was a mixture of fresh vegetable, garden and fruit waste (VGF) and structured material. The biowaste was derived from the organic fraction of municipal solid waste, obtained from the waste treatment plant of Schendelbeke, Belgium. The biowaste had a moisture content and a volatile solids content of more than 50% and a pH above 5. Water was added to the biowaste during the test to ensure a sufficient moisture level. At the start a pH of 6.9 was measured, and after 1.5 week of compositing, the pH increased above 8.5. The maximum temperature during composting ranged from above 60° C. to below 75° C. The daily temperature was above 60° C. during more than 1 week. After 1.5 week of composting, the bin was placed in an incubation room at 45° C. to ensure the daily temperature remained above 40° C. during at least 4 weeks. The daily temperature remained at or above 40° C. for the entire test period. The temperature and exhaust gas were regularly monitored. During composting, the content of the bin was manually turned, weekly during the first month and later on every 2 weeks, at which times samples were visually monitored. During the entire test period, oxygen concentration remained above 10%, which ensured aerobic conditions. This test method is predictive of whether a substrate would pass the test for biodegradability set forth in ASTM Standard D6868-03.

### Reference Example 2

### Treatment Procedure and Cobb Sizing

Unbleached kraft papers (24 pt and 45 pt), which were light brown in color, were treated with various solutions containing chlorosilanes in pentane. The papers were drawn through a machine as a moving web where the treatment solution was applied. The line speed was typically 10 feet/minute to 30 ft/min, and the line speed and flow of the treating solution were adjusted so that complete soak-through of the paper was achieved. The paper was then exposed to sufficient heat and air circulation to remove solvent and volatile silanes. The paper was then exposed to an atmosphere of ammonia to neutralize HCl. The hydrophobic attributes of the treated papers were then evaluated via the Cobb sizing test and immersion in water for 24 hours.

The Cobb sizing test was performed in accordance with the procedure set forth in TAPPI testing method T441 where a 100 cm² surface of the paper was exposed to 100 milliliters (mL) of 50° C. deionized water for three minutes. The reported value was the mass (g) of water absorbed per square meter (g/m²) by the treated paper.

### Examples 1-3

Samples of light brown kraft paper having 24 pt or 45 pt thickness were treated and tested for Cobb value according to the method described in Reference Example 2. The results are in Table 1. Samples 1 and 3 were 45 pt (1.14 mm thick) kraft paper. Samples 1 and 3 each had a surface area/volume ratio of 17.9 (Table 2). Sample 2 was 24 pt (0.61 mm thick) kraft paper. Sample 2 had a surface area/volume ratio of 33.2. The amount and type of resin in sample 2 was determined by converting the resin to monomeric chlorosilane units and quantifying such using gas chromatography pursuant to the procedure described in “The Analytical Chemistry of Silicones,” Ed. A. Lee Smith. Chemical Analysis Vol. 112, Wiley-Interscience (ISBN 0-471-51624-4), pp 210-211.

TABLE 1
Cobb sizing test for the untreated and treated papers.
The treated papers are substantially more hydrophobic
than the untreated papers.

Cobb (g/m²)

| Sample | Top | Bottom |
|---|---|---|
| Untreated 24 pt (comparative) | 700 | 716 |
| Untreated 45 pt (comparative) | 1136 | 1051 |
| 1 (5% MeSiCl₃) (45 pt) | 74 | 68 |
| 2 (20% MeSiCl₃) (24 pt) | 47 | 48 |
| 3 (3.4% MeSiCl₃) (45 pt) | 60 | 56 |

Table 2 shows the silicone resin content of each sample, and the thickness of the paper.

| | | | Surface |
|---|---|---|---|
| | Treatment Level (MeSiO_{3/2} | | Area/Volume |
| Sample | content) | Caliper | Ratio |
| Untreated | Non-detectable | 24 pt | n/a |
| (comparative) | | | |
| Untreated | Non-detectable | 45 pt | n/a |
| (comparative) | | | |
| Example 1 | 0.30% | 45 pt | 17.9 |
| Example 2 | 0.41% | 24 pt | 33.2 |
| Example 3 | 0.80% | 45 pt | 17.9 |

Sixteen slide frames containing test material specimens of each example of treated paper were prepared. The most disintegration was observed for Sample 2. After 6 weeks of composting, small holes began to appear in each test material, and each test material had become weak. Two weeks later, big holes were observed in each test material of the major part of the slide frames. The disintegration proceeded, and at the end of the test, only small pieces of test material remained present at the borders of the major part of the slide frames. Only in a few slide frames more test material was observed. This test indicated that Sample 2 should pass the test for biodegradability set forth in ASTM Standard D6868-03. The results are in Tables 3 and 4.

The disintegration of Samples 1 and 3 proceeded comparably to one another. During the first 8 weeks of the test, no clear signs of disintegration were observed in any of the slide frames for any of Samples 1 and 3. However, the test materials became weak and the color of the test materials became dark brown, even though the test materials did not fall apart. At the end of the test, Samples 1 and 3 each had test material present in the major part of each slide frame. Only in some slide frames holes were present in the test material, but color had changed to dark brown.

The color change (darkening) and strength change in Samples 1 and 3 indicated that these samples would be biodegradable under commercial or residential composting conditions, had the test been continued for more than 12 weeks.

Table 3 shows a summary of the disintegration test results.

TABLE 3

| Sample | 4 Weeks | 8 Weeks | 12 Weeks |
|---|---|---|---|
| 1 | Mainly intact | Mainly intact | Mainly intact |
| | Color: Dark Brown | | Some slide frames with holes |
| | Test material had | | in the samples |
| | become weak | | |
| 2 | Mainly intact | Big holes and tears | In the major part of the slide |
| | Color: Dark Brown | Few intact | frames, only small pieces |
| | Test material had | | remained present at the borders |
| | become weak | | of the slide frames, |
| | | | Few slide frames with more |
| | | | test material |
| 3 | Mainly intact | Mainly intact | Mainly intact |
| | Color: Dark Brown | | Some slide frames with holes |
| | Test material had | | in the samples |
| | become weak | | |

Table 4 shows an Average % Disintegration for each of the 16 slide frames after 12 weeks of composting. The values 1 through 16 were estimated by visual inspection of the sixteen samples. The last column shows the average of the 16 values.

| Slide | | | | | | | | | | | | | | | | | |
|---|---|---|---|---|---|---|---|---|---|---|---|---|---|---|---|---|---|
| Frame/ | | | | | | | | | | | | | | | | | |
| Sample | 1 | 2 | 3 | 4 | 5 | 6 | 7 | 8 | 9 | 10 | 11 | 12 | 13 | 14 | 15 | 16 | Average |
| 1 | 0 | 0 | 0 | 0 | 0 | 0 | 0 | 0 | 0 | 0 | 12 | 0 | 90 | 50 | 30 | 80 | 16 |
| 2 | 0 | 40 | 40 | 80 | 95 | 80 | 90 | 100 | 95 | 95 | 100 | 95 | 100 | 90 | 95 | 95 | 81 |
| 3 | 0 | 0 | 0 | 0 | 0 | 0 | 0 | 0 | 0 | 0 | 70 | 30 | 80 | 60 | 90 | 80 | 26 |

1. A method comprising:
1) penetrating a substrate with a halosilane, and
2) forming a silicone resin from the halosilane,
where the product of step 2) is both hydrophobic and biodegradable.

2. The method of claim 1, further comprising: step 3) exposing the substrate to a basic compound, where the product of step 3) is both hydrophobic and biodegradable.

3. (canceled)

4. (canceled)

5. The method of claim 1, where the product of step 2) contains less than 1% of the silicone resin.

6. The method of claim 1, where the halosilane comprises the formula RₐSiCl_{b}H_{(4-a-b)} where subscript a has a value ranging from 0 to 3, subscript b has a value ranging from 1 to 4, and R is an alkyl, alkenyl, aryl, aralkyl, or alkaryl group containing 1 to 20 carbon atoms.

7. The method of claim 6, where the halosilane is applied as a liquid in step 1).

8. The method of claim 6, where the halosilane is applied as a vapor in step 1).

9. (canceled)

10. The method of claim 1, where the halosilane is provided in a solution comprising the halosilane and one or more additional ingredients.

11.-14. (canceled)

15. A method comprising:
1) penetrating a substrate with a plurality of halosilanes, and
2) forming a silicone resin from the plurality of halosilanes,
where the product of step 2) is both hydrophobic and biodegradable.

16. The method of claim 15, further comprising: 3) step exposing the substrate to a basic compound, where the product of step 3) is both hydrophobic and biodegradable.

17. The method of claim 15, where the plurality of halosilanes comprises at least a first halosilane and a second halosilane different from the first halosilane, wherein the plurality of halosilanes comprises a total halosilane concentration comprising 20 mole percent or less of monohalosilanes, 70 mole percent or less of monohalosilanes and dihalosilanes and at least 30 percent of trihalosilanes and tetrahalosilanes.

18.-20. (canceled)

21. The method of claim 15, where the plurality of halosilanes is applied as one or more liquids in step 1).

22. The method of claim 15, where the plurality of halosilanes is applied as one or more vapors in step 1).

23. (canceled)

24. The method of claim 15, where the plurality of halosilanes is provided in a solution comprising the plurality of halosilanes and one or more additional ingredients.

25. (canceled)

26. (canceled)

27. The method of claim 24, where total halosilane concentration ranges from 20 mole percent to 95 mole percent of a trihalosilane in the solution.

28. (canceled)

29. An article comprising:
a cellulosic substrate; and,
0.01% to 0.99% of a silicone resin, where the silicone resin is produced from treating the cellulosic substrate with a halosilane, and
the article is both hydrophobic and biodegradable.

30. (canceled)

31. (canceled)

32. The article of claim 29, where the halosilane comprises the formula RₐSiCl_{b}H_{(4-a-b)} where subscript a has a value ranging from 0 to 3, subscript b has a value ranging from 1 to 4, and R is an alkyl, alkenyl, aryl, aralkyl, or alkaryl group containing 1 to 20 carbon atoms.

33. (canceled)

34. The article of claim 29, where the substrate comprises paper, cardboard, boxboard, wood, wood products, wallboard, textiles, starches, cotton or wool.

35. (canceled)

36. (canceled)

37. An article comprising:
a cellulosic substrate; and,
0.01% to 0.99% of a silicone resin, where the silicone resin is produced from treating the cellulosic substrate with a plurality of halosilanes, and the article is both hydrophobic and biodegradable.

38. The article of claim 37, where the plurality of halosilanes comprises at least a first halosilane and a second halosilane different from the first halosilane, where the plurality of halosilanes comprises a total halosilane concentration comprising 20 mole percent or less of monohalosilanes, 70 mole percent or less of monohalosilanes and dihalosilanes and at least 30 percent of trihalosilanes and tetrahalosilanes.

39.-41. (canceled)

42. The article of claim 37, where the substrate comprises paper, cardboard, boxboard, wood, wood products, wallboard, textiles, starches, cotton or wool.

43. (canceled)

44. (canceled)
